(19) United States
(12) Patent Application Publication
(10) Pub. No.: US 2026/0149635 A1
(43) Pub. Date: May 28, 2026

(54) TELEMETRY STANDARDIZATION FOR MULTI-CONFIGURATION PROTOCOLS

(71) Applicant: MELLANOX TECHNOLOGIES, LTD., Yokneam (IL)

(72) Inventor: Siddanagouda Khot, Cupertino, CA (US)

(21) Appl. No.: 19/316,991

(22) Filed: Sep. 2, 2025

Related U.S. Application Data
(60) Provisional application No. 63/725,218, filed on Nov. 26, 2024.

(51) Int. Cl. H04L 41/0803

(52) U.S. Cl. CPC H04L 41/0803

(57) ABSTRACT

A network, one or more circuits, or a method disclosed herein may include or be associated with one or more network devices for standardizing telemetry in the network. The network may be adapted to handle different network configuration protocols and different telemetry protocols using a routing process and a telemetry process provided for the network. The routing process may allow generation of telemetry data for the different network configuration protocols. The telemetry process may allow repackaging of the telemetry data to be specific to at least one of the network configuration protocols and to at least one of the different telemetry protocols.

### CROSS-REFERENCE TO RELATED APPLICATIONS

This is a Non-Provisional Patent Application which is related to and which claims the benefit of priority to U.S. Provisional Patent Application 63/725,218, filed on Nov. 26, 2024, and entitled “TELEMETRY STANDARDIZATION FOR MULTI-CONFIGURATION PROTOCOLS,” which is hereby incorporated by reference herein in its entirety and for all intents and purposes.

### TECHNICAL FIELD

The disclosure herein generally relates to handling telemetry in a network, and may specifically relate to standardizing of telemetry for a network capable of different network configuration and telemetry protocols.

### BACKGROUND

A network may use software agents for telemetry purposes. A software agent may be tied to a specific telemetry or network configuration protocol. The software agent may not be able to work across a subscription model. In one instance, a software agent may be part of a software platform that can perform Free Range Routing® (FRR) to allow a user to collect telemetry data. The user may need to feed the telemetry data into a telemetry service for additional processing. The telemetry service may be compatible with OpenTelemetry® (OTEL) or another network configuration protocol, and the telemetry data may be specific to the network configuration protocol. The telemetry service may be part of the same network device as the FRR or may be in a different network device.

### BRIEF DESCRIPTION OF DRAWINGS

FIG. 1 illustrates a system that is subject to standardized telemetry for a network, according to at least one embodiment;

FIG. 2 illustrates detailed aspects of a system for standardized telemetry in a network, according to at least one embodiment;

FIG. 3A illustrates details of different processes in a system for standardized telemetry, according to at least one embodiment;

FIG. 3B illustrates details associated with responses and handling of responses in at least one process of a system for standardized telemetry, according to at least one embodiment;

FIG. 4 illustrates computer and processor aspects used in a system for standardized telemetry, according to at least one embodiment;

FIG. 5A illustrates a process flow for standardized telemetry, according to at least one embodiment;

FIG. 5B illustrates a process flow for performing health checks in a system for standardized telemetry, according to at least one embodiment; and

FIG. 6 illustrates an example datacenter, in which at least one embodiment from FIGS. 1-5B may be used.

### DETAILED DESCRIPTION

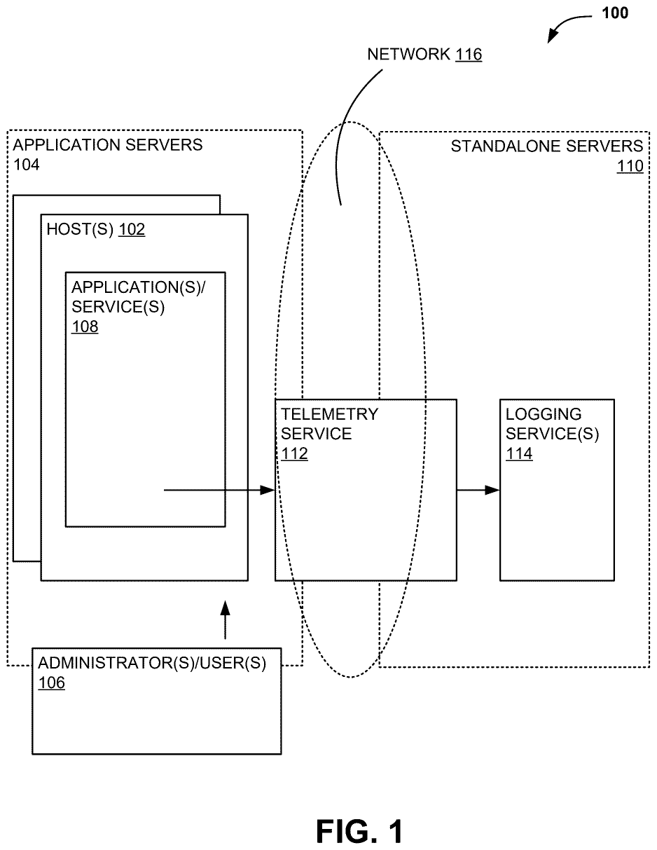

FIG. 1 illustrates a system 100 that is subject to standardized telemetry for a network, according to at least one embodiment. The telemetry may be in reference to metrics, logs, and traces associated with an application or service performing a workload. The metrics may include quantitative, or performance measurements associated with a host or a network device performing one or more applications or services associated with a workload. The metrics may include processor usage, memory usage, network traffic, request latency, and error rates. The logs may include text information or records of events that occur within the host. The events may include application errors, security events, and system messages. The traces may include any record of operations performed through a distributed environment. In one example, the traces may include a duration of the operations, any relationships between the operations, and any errors transmitted through the operations.

The standardized telemetry herein may be in reference to an ability, in the system 100, to handle different network configuration protocols and different telemetry protocols, which represent multi-configuration protocols in a system 100. In one example, the different telemetry protocols may include different data formats and packages associated with OpenTelemetry (OTEL) or gRPC Network Management Interface (gNMI). The different network configuration protocols may include different data formats and packages associated with BGP (Border Gateway Protocol), OSPF (Open Shortest Path First), RIP (Routing Information Protocol), IS-IS (Intermediate System-to-Intermediate System), PIM (Protocol Independent Multicast), LDP (Label Distribution Protocol), BFD (Bidirectional Forwarding Detection), Babel, PBR (Policy-Based Routing), OpenFabric, or VRRP (Virtual Router Redundancy Protocol).

The different telemetry protocols and the different network configuration protocols may be associated with different acquisition, processing, and presenting of telemetry data for specific routing purposes but may also include other system or application purposes. In one example, a telemetry process used within the system 100 may be a standalone telemetry process that may interface with a routing process (such as a Free Range Routing (FRR) process) to package requests, such as subscription requests, for telemetry data. In one example, the telemetry data may be associated with routing or networking (and other system-related) metrics, logs, or traces, based in part on a request from a host or a network device. The routing process herein is able to provide a library suitable to a network configuration protocol so that telemetry data for a request may be provided in a format of a network configuration protocol relevant to the request. The routing process may be able to package or repackage (such as translate, convert, or format) telemetry data for at least one of the different network configuration protocols, while the telemetry process may be able to additionally repackage the telemetry data to be specific to at least one of the different telemetry protocols, in addition to the at least one of the different network configuration protocols.

In some examples, a routing process, such as an FRR process, may perform algorithms associated with different protocols to provide an optimal solution for point-to-point reachability in a network. At the same time, with the advent of network observability and network tracking, it may be important to access telemetry associated with the functioning of the algorithms for the point-to-point reachability in the network. There may be an additional overhead on components performing the FRR process, including overhead associated with the network observability and network tracking placed on the FRR process. The introduction of a telemetry process may allow the telemetry process to absorb the overhead from the components performing the FRR process. In some examples, the telemetry process takes over from the FRR process to perform the overhead described. In some examples, the FRR process may instruct, provide, or otherwise support, allow, or cause the telemetry process to perform the overhead intended for the FRR process. As such, the telemetry process herein is a separate process from the FRR process (or any other routing process). There may be separate processing, memory, and other aspects required to perform the telemetry process, separately from the FRR process, in some examples. In some examples, in a Linux® environment, the telemetry process and the routing process are spawned as separate processes with different process identifiers (IDs) having different memory stacks. In other operating environments, as well, the telemetry process and the routing process may be spawned as separate processes and may use separate components or may use shared components at different times to ensure, allow, or support removal of any overhead to the routing process with respect to telemetry and telemetry data. The different processes may be different than threads within a process, in some examples.

Separately, the telemetry process may be able to package a subscription request as part of the standardization of telemetry data so that a receiving logging service, which may be configured for a specific telemetry protocol and a specific network configuration protocol, may be able to appreciate the telemetry data and perform any further processing and presenting of the telemetry data. The telemetry process can parse configuration files associated with the requests and may relay the request to the routing process. The routing process may solicit the requests from the telemetry process. The routing process may also provide the telemetry data for the telemetry process. The telemetry process herein is, therefore, not restricted by a specific network configuration protocol or a specific telemetry protocol. The system 100 for standardized telemetry may use XPath handling logic (from the XSLT® standard) and gRPC® (or other remote procedure call (RPC) frameworks) for communication between one or more of the processes or the host.

In one example, one or more of the host(s), network devices of a network, or standalone servers may be managed by or may be part of different entities. One or more of the host(s), network devices of a network, or standalone servers may be able to perform authentication processes using an authentication mechanism that is readily apparent upon studying this disclosure. The authentication processes may be supported by individual ones of the host, the network devices, and the standalone server. The authentication processes may allow the telemetry process to intervene with respect to telemetry-related subscription requests. The authentication processes may allow the telemetry process to process telemetry data for different network configuration protocols and for different telemetry protocols so that it may be suitable for different logging services. In one example, a telemetry process may provide the subscription requests to the routing process using the authentication mechanism that may include opening and using a channel for gRPC communication. In another example, the telemetry process can intercept a request from a known Internet Protocol (IP) address or may be associated with an authentication process in a component of a user experience interface, in another example. In another example, a user experience interface may be able to handle and distribute all requests, which may include the subscription requests, to appropriate processes associated therewith.

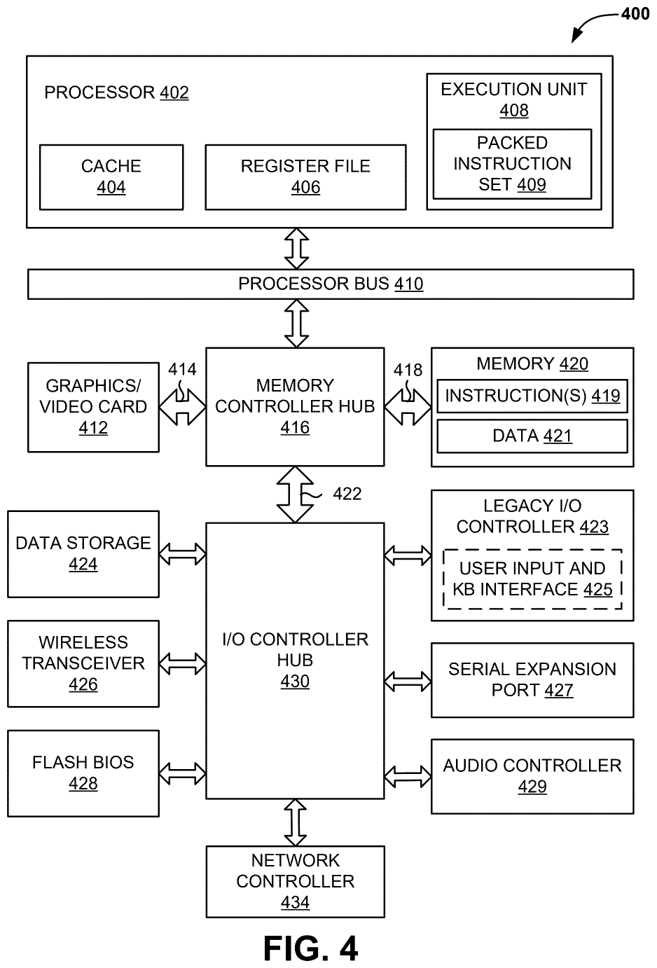

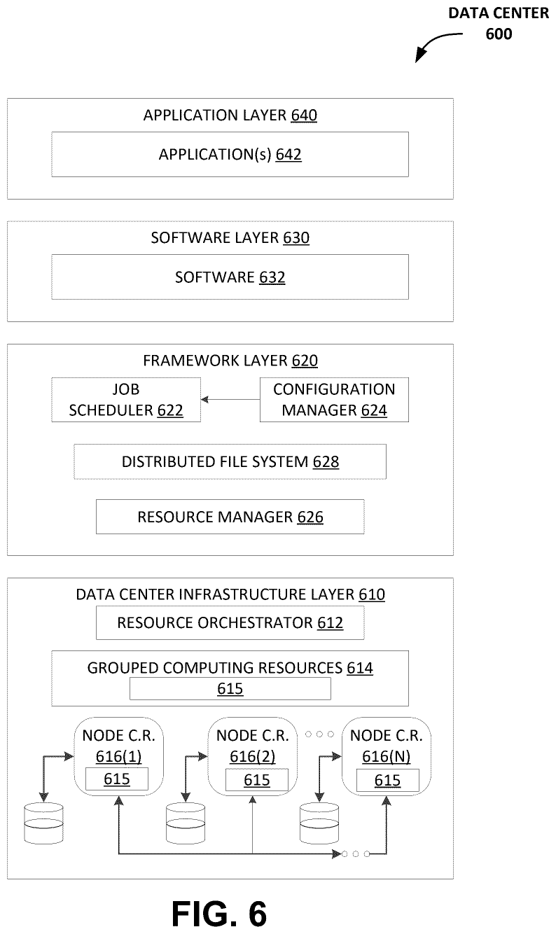

The system 100 may include one or more hosts 102 that may be part of a group of application servers 104. The application servers 104 may perform a workload for one or more users or administrators 106. The application servers 104 may use one or more applications or services 108 and hardware in the hosts 102 to perform the workload. FIGS. 4 and 6 provide further details of the hardware and some aspects of the applications or services 108. The hosts may be part of a datacenter and the workload may be performed in the datacenter. The system 100 may also include one or more standalone servers 110 that may be associated with the one or more application servers 104. The standalone servers 110 may include different processes 204, 206 or services 112, 114 to perform standardized telemetry.

In one example, the standalone servers 110 may include a telemetry service 112 and a logging service 114. In one example, one or more of the telemetry service 112 and the logging service 114 may be provided using the hosts 102 or within resources associated with the hosts 102. The telemetry service 112 and the logging service 114 may be managed by different entities or may be managed by a single entity, which may also be the same or may be different than an entity providing the hosts 102 or the underlying resources of the hosts 102. The underlying resources may be aspects discussed with respect to one or more of FIG. 4 or 6 herein. In an example, at least the logging server 114 is managed by an entity capable of providing proprietary processing and presentation of the telemetry data, according to a proprietary one of the telemetry protocols 208B. For instance, although at least format for the telemetry data may be provided by a telemetry process 204 of the telemetry service 112, the format is only so that the proprietary one of the telemetry protocols 208B can appreciate and consume the telemetry data received. The proprietary one of the telemetry protocols 208B, in a logging service 114, can perform further processing of the telemetry data according to further proprietary processing features that are distinct from the telemetry process 204.

The standalone servers 110 may represent a different entity handling one or more of the telemetry service 112 and the logging service 114 by also handling underlying resources performing one or more of the telemetry service 112 and the logging service 114. The hosts 102 may be provided using resources of different entities as well. The telemetry service 112 may include telemetry libraries to capture traces, metrics, and logs associated with telemetry data for at least one of the applications or services 108. The logging service 114 may be able to receive the telemetry data and may be able to perform further processing of the telemetry data for consumption or utilization by the one or more users or administrators 106 or by the application servers 104. In at least one example, the services 112, 114 to perform standardized telemetry may be part of the hosts 102. The application servers 104 and the standalone servers 110 may be part of a network 116 that is able to support different network configuration protocols and different telemetry protocols.

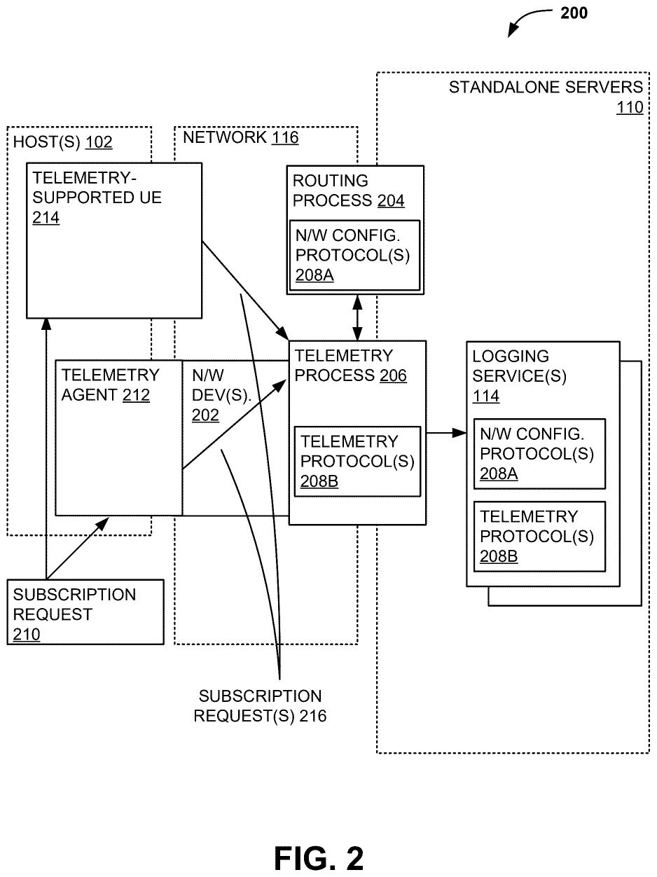

FIG. 2 illustrates detailed aspects 200 of a system for standardized telemetry in a network, according to at least one embodiment. The detailed aspects 200 may be provided within the system 100 in FIG. 1. As illustrated in FIG. 2, the network 116 may include one or more network devices 202 (N/W DEVS.). The network devices 202 may be configured to handle different network configuration protocols 208A and different telemetry protocols 208B that may be associated with one or more logging services 114. In one example, handling of different network configuration protocols and different telemetry protocols, as used herein, may be in reference to an ability of a network device, host, or standalone server to repackage or package telemetry data or subscription requests to different formats of the multi-configuration protocols. For example, the network devices 202 may be able to use a telemetry process 206 and a routing process 204 to provide telemetry data that may be packaged or repackaged according to a specific one of the different network configuration protocols 208A and to a specific one of the different telemetry protocols 208B, thereby allowing the network devices 202 to include configuration to handle the multi-configuration protocols. The telemetry process 206 can route the telemetry data to a specific one of the logging services 114 for further handling. The one or more network devices 202 may include a Linux operating system (OS), such as Nvidia Cumulus® Linux® OS. In one example, there may be different logging services 114 to provide proprietary processing and presentation of the telemetry data according to different telemetry protocols 208B.

FIG. 2 also illustrates that the handling of the different network configuration protocols 208A and different telemetry protocols 208B may be performed by the hosts 102 or by the standalone servers 110. In FIG. 2, one or more of the network devices 202 or the standalone servers 110 may include one or more of the telemetry process 206 or the routing process 204. Based in part on a proprietary or non-proprietary nature of the logging service, it is also possible that one or more of the network devices 202 or the standalone servers 110 may include one of the logging services 114 with different protocols that may be open protocols. For instance, there may be at least one telemetry protocol and at least one network configuration protocol that may benefit from a logging service that may be within the network devices 202. In another example, one or more of the hosts 102 may include one or more of the telemetry process 206 or the routing process 204, and may include one of the logging services 114. For example, the hosts 102 may include different resources that may be shared or proprietary to different entities. The different entities may be responsible for one or more of the telemetry process 206, the routing process 204, or at least one of the logging services 114.

In one example, one or more network devices 202 may be associated with or may include the routing process 204 and the telemetry process 206. The routing process 204 and the telemetry process 206 may be part of a telemetry service 112 enabled in the system 100. The telemetry service 112 may be a self-contained software feature of the system 100 and can provide specific functions associated with telemetry requirements, including the standardized telemetry herein. In one example, the telemetry service may include web services (such as REST APIs, SOAP services), cloud-based services (SaaS, PaaS, IaaS), or microservices. The telemetry service 112 may provide a telemetry process 206 and may support a routing process 204 within the system 100.

The routing process 204 and the telemetry process 206 may be structured operations that may include development, deployment, and maintenance support for the applications and services 108 of the one or more hosts 102. The telemetry service 112 may be used to cause deployment, instantiation, or installation of the routing process 204 and the telemetry process 206, along with any of the other features that can enable the standardized telemetry within the system 100. In one example, the routing process 204 may include a library of different network configuration protocols 208A, including for BGP (Border Gateway Protocol), OSPF (Open Shortest Path First), RIP (Routing Information Protocol), IS-IS (Intermediate System-to-Intermediate System), PIM (Protocol Independent Multicast), LDP (Label Distribution Protocol), BFD (Bidirectional Forwarding Detection), Babel, PBR (Policy-Based Routing), OpenFabric, and VRRP (Virtual Router Redundancy Protocol). In another example, the standardizing of telemetry herein may be limited to routing-based telemetry at least because the routing-based telemetry may be different for different network configuration protocols that may have different routing nuances that the telemetry process working with the routing process is able to address.

While each of the logging services 114 may be able to perform proprietary processing and presentation of the telemetry data using a specific one of its different telemetry protocols 208B, it is possible that one of the logging services 114 may be able to include multiple ones of the different network configuration protocols 208A and multiples ones of the different telemetry protocols 208B. This allows each of the logging services 114 to perform either a specific one or different ones of proprietary processing and presentation of the telemetry data.

Telemetry process 206 may communicate with the routing process 204 to use its library of routing protocols and to repackage telemetry data that is responsive to the received requests. The repackaging of the telemetry data makes the telemetry data specific to at least one of the different network configuration protocols 208A, in support of the standardized telemetry herein. The routing process 204 allows generation of telemetry data for the different network configuration protocols 208A. The telemetry process 206 allows repackaging of the telemetry data to be specific to at least one of the different network configuration protocols 208A, as provided by the routing process 204, in addition to being specific to at least one of the different telemetry protocols 208B.

In one example, there may be different subscription requests 216 made to the telemetry process 206. The different requests 216 may be formatted as XPath requests and may be a version of the subscription requests 210 received in a telemetry agent or a telemetry-supported user experience (UE) 214 interface. The telemetry-supported UE 214 interface may be a user interface for managing and configuring one or more of the network devices 202 of the network 116, and may be adapted to support or provide requests to the telemetry process 206. A user or administrator 106 may configure individual ones of the subscription requests 210 through a command made at the telemetry-supported UE 214 interface for a specific one of the network configuration protocols 208A. The subscription requests 210 may include a routing subscription request.

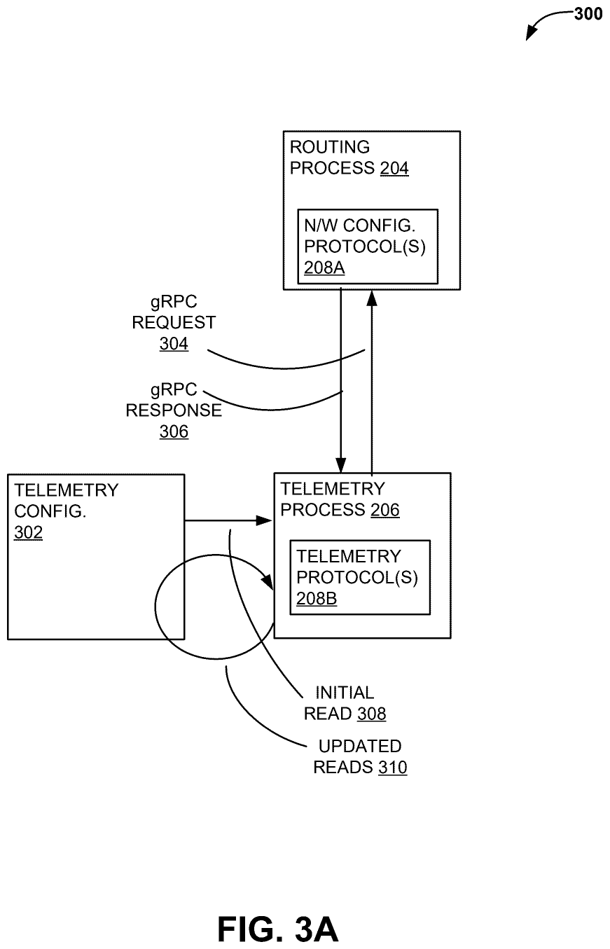

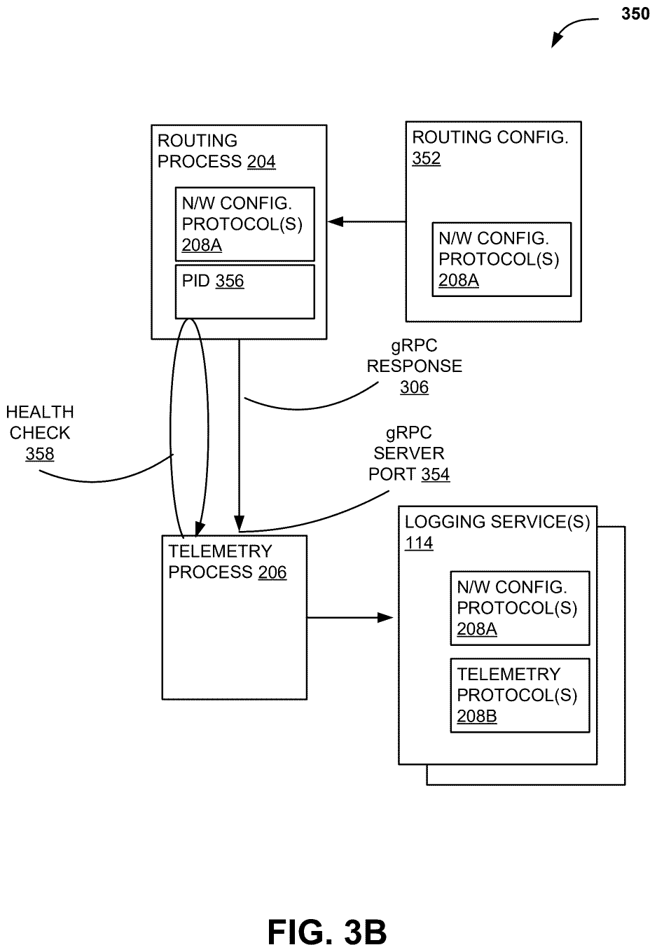

Separately, for devices (including network devices 202 or hardware in the host 102) and other applications to be able to make independent ones of the subscription requests 210, a telemetry agent 212 may be used. In one example, the telemetry agent 212 may be part of the telemetry-supported UE 214 interface. A telemetry agent 212 may be specific to a network device 202, hardware of one of the hosts 102, or an application of one of the hosts 102. A telemetry agent 212 may configure the subscription requests 210 for the telemetry process 206. In one example, a telemetry agent 212 may be associated with one of the network configuration protocols 208A that may be specific to gNMI. The subscription requests 210 may be updated in a configuration file, such as a telemetry configuration 302 (config.) file in FIG. 3A. The telemetry configuration 302 file may be in a YAML® format. In one example, the telemetry agent 212 may also be configured for network devices 202 so that a telemetry agent 212 on a network device (such as a router or a switch) can collect metrics, logs, or traces that may be subject to the standardized telemetry thereafter. The different requests 216 made through the telemetry process 206 may be the subscription requests 210 or a variation thereof, such as formatted by the telemetry-supported UE 214 interface.

FIG. 3A illustrates details 300 of different processes in a system for standardized telemetry, according to at least one embodiment. As illustrated in FIG. 3A, the telemetry process 206 may read the subscription requests 210 from the telemetry configuration 302 file, which may be in a specific format (such as a “. conf” file that is readable and executable to the telemetry process 206). The telemetry process 206 may construct a gRPC request 304 for communication with the routing process 204. Once constructed, the telemetry process 206 may provide the gRPC request 304, associated with the subscription requests 210, to the routing process 204. The routing process 204 allows generation of telemetry data using its library of different network configuration protocols 208A to provide a native format of the telemetry data, responsive to at least one of the different requests 216, to the telemetry process 206. The native format may be YANG®.

The telemetry process 206 may listen to the routing process 204 for a gRPC response 306 on a gRPC server port associated with the telemetry process 206. Upon receiving a gRPC response 306, the telemetry process 206 may translate (or repackage) the native format into one of the different telemetry protocols 208B, including into OTEL or gNMI. The translated or repackaged telemetry data may be OTEL-specific or gNMI-specific telemetry data, in addition to being of a specific network configuration protocol as provided by the routing process 204. The telemetry process 206 may send a gRPC message having the telemetry data to a logging service 114 associated with the specific network configuration protocol and the specific telemetry protocol to perform a proprietary further processing and presentation of the telemetry data.

In FIG. 3A, once a user or administrator 106 configures at least one of the subscription request 210 through commands at a telemetry-supported UE 214 interface for a specific telemetry protocol (such as OTEL), the subscription request 210 may be updated in a telemetry configuration 302 file. For certain ones of the network devices 202 and other hardware of the host 102, the telemetry agent 212 may configure at least one of the subscription requests 210 to cause an update in the telemetry configuration 302 file. In one example, a format of the telemetry configuration 302 file may include a mode indicator (or mode stream) that may be indicative of a specific mode or behavior for a particular software or service associated with an application or service 108 or associated with a network device 202 or hardware of the host 102. The format of the telemetry configuration 302 file may include a class structure of the mode and a sample interval time to indicate a frequency (such as 30 seconds) for checking for updates related to the telemetry configuration 302 file.

The format may also include a path or block indicating parameters for establishing and maintaining a specific network configuration protocol in a peering relationship (such as /frr-bgp-peer:peer/10.1.4.2/state or /frr-bgp-peer:peer/swp2/state). The telemetry process 206 may initially read 308 the subscription requests from the telemetry configuration 302 file to initiate its process. The telemetry process 206 may perform subsequent updated reads 310 whenever the telemetry configuration 302 file is updated or as per the frequency indicated. The telemetry process 206 may construct its gRPC request 304 and may send the gRPC request 304 to the routing process 204.

FIG. 3B illustrates details 350 associated with responses and handling of responses in at least one process of a system for standardized telemetry, according to at least one embodiment. As illustrated, the telemetry process 206 may open a gRPC server port 354 to receive the gRPC response 306 with telemetry data from routing process 204 in the native format. The routing process 204 may have updated routing configuration provided from a routing configuration 352 (config.) file at intervals or when necessary. The routing configuration 352 file may provide configuration specific to a routing, including to define a routing protocol, interfaces, and network parameters. For instance, the configuration may include specification of a router's unique identifier, hostname, logging facility, logging level, and any authentication or access information. The routing configuration 352 file may be apparent upon studying this disclosure and may allow a routing process to specify interface names, routing addresses, and protocol configurations. The protocol configurations may include configuration for BGP, definition of a neighbor with peer IP addresses, definition of peer numbers, definition of a BGP neighbor, process IDs, configuration for Open Shortest Path First (OSPF), router configuration for RIP, router configuration for ISIS, and the like.

Upon receiving the gRPC response 306 from routing process 204, the telemetry process 206 may translate or repackage the native format of the telemetry data into the telemetry protocol-specific version of the telemetry data. The telemetry process may construct a gRPC message and may send it to a logging service 114 for further processing. The telemetry process 206 may also perform periodic health checks associated with a health of the routing process 204. For example, when the routing process 204 is deployed, instantiated, or started in any manner, it has an identifier 356 (such as a process identifier or PID) assigned to it. The telemetry process 206 may be able to perform a health check 358 for the routing process 204 in a period or predetermined manner. The routing process 204 may include the identifier 356, which may be subject to the changes upon restarting the routing process 204. The health check 358 may be performed to determine that the identifier 356 has changed. The telemetry process 206 can repeat at least one subscription request for the telemetry data by reading at least one subscription request from a configuration file. The telemetry process 206 can perform the repackaging of the telemetry data to be specific to at least one of the different network configuration protocols and at least one of the different telemetry protocols.

For instance, when the routing process 204 is subject to any restarts, the PID may change. The telemetry process 206 may be able to perform the health check 358 in a periodic manner to confirm or update its reference to the PID of the routing process 204. The telemetry process 206 is able to reapply at least one of the subscription requests 210 by at least one of the subsequent updated reads 310 of the subscription requests from the telemetry configuration 302 file. The telemetry process 206 is able to construct its gRPC messages, as part of its configuration to repackage the subscription requests with gRPC messaging, for the routing process 204. The telemetry process 206 may send the gRPC message to a restarted version of the routing process 204.

FIG. 4 illustrates computer and processor aspects 400 used in a system for standardized telemetry, according to at least one embodiment. The computer and processor aspects 400 may be associated with providing (deploying, instantiating, or starting) one or more of the processes 204, 206 for standardized telemetry. The computer and processor aspects 400 may also be associated with subsequent processing to provide the standardized telemetry to a logging service 114. The subsequent processing may include all aspects of repackaging (including translation, formatting, or converting, as used interchangeably herein) to retrieve and provide telemetry data to be specific to at least one of the different network configuration protocols and at least one of the different telemetry protocols. Therefore, the computer and processor aspects 400 may include hardware and software features to support or perform any of FIGS. 1-3B and 5A-6.

The computer and processor aspects 400 may be performed by one or more processors that include a system-on-a-chip (SOC) or some combination thereof formed with a processor that may include execution units to execute an instruction, according to at least one embodiment. Such one or more processors may include CPUs, data processing units (DPUs), and graphics processing units (GPUs) and may be within a host 102 or a network device 202. In one instance, the one or more network devices 202 may include an Nvidia Cumulus Linux operating system performed by a processor in support of the standardized telemetry described herein.

In at least one embodiment, the computer and processor aspects 400 may include, without limitation, a component, such as a processor 402 to employ execution units including logic to perform algorithms for process data, in accordance with present disclosure, such as in an embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS® operating system available from Microsoft® Corporation of Redmond, Wash., although other operating systems (UNIX® and Linux®, for example), embedded software, and/or graphical user interfaces, may also be used.

Embodiments may be used in other devices, such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), a system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3B and 5A-6 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache 404 may reside externally to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, the devices illustrated in FIG. 4 may be interconnected with proprietary interconnects, standardized interconnects (e.g., PCIe®) or some combination thereof. In at least one embodiment, one or more components of the computer and processor aspects 400 that are interconnected using compute express link (CXL) interconnects.

One or more circuits of the computer and processor aspects 400 may be provided in one or more of the hosts 102, the network devices 202, or the standalone servers 110. One or more circuits of the computer and processor aspects 400 may be configured to handle different network configuration protocols of a network and to handle different telemetry protocols. The one or more circuits may be associated with a routing process and with a telemetry process. The routing process may allow generation of telemetry data for the different network configuration protocols. The telemetry process may allow repackaging of the telemetry data to be specific to at least one of the different network configuration protocols and to at least one of the different telemetry protocols.

The one or more circuits of the computer and processor aspects 400 may be configured for one or more of: execution of a Linux operating system, routing using Free Range Routing (FRR), and communication using gRPC between the routing process and the telemetry process. The one or more circuits of the computer and processor aspects 400 may include one or more of a telemetry agent or a user experience interface. The telemetry agent or the user experience interface may be to provide subscription requests associated with the telemetry data to the telemetry process.

The one or more circuits of the computer and processor aspects 400 may include a library, of the routing process, comprising the different network configuration protocols to provide a native format of the telemetry data to the telemetry process. The one or more circuits of the computer and processor aspects 400 may include configuration, of the telemetry process, to repackage the telemetry data from the native format to a format specific to the at least one of the different telemetry protocols.

The one or more circuits of the computer and processor aspects 400 may be such that an included telemetry process may be used to perform a health check for the routing process. The routing process may include an identifier which may be subject to changes upon restarting the routing process. The health check may be to determine that the identifier has changed. The telemetry process may be to repeat at least one subscription request for the telemetry data by reading the at least one subscription request from a configuration file and performing the repackaging of the telemetry data. The repackaging may be performed specific to the at least one of the different network configuration protocols and the at least one of the different telemetry protocols.

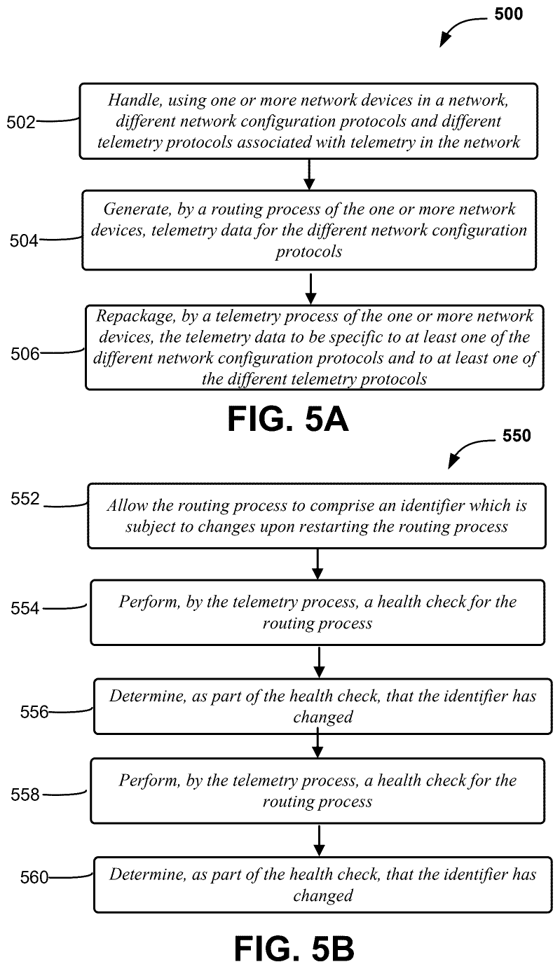

FIG. 5A illustrates a process flow or method 500 for standardized telemetry, according to at least one embodiment. The method 500 may include a step to handle 502, using one or more network devices in a network, different network configuration protocols and different telemetry protocols associated with telemetry in the network. The method 500 may include a step to generate 504, by a routing process of the one or more network devices, telemetry data for the different network configuration protocols. The method 500 may include a step to repackage 506, by a telemetry process of the one or more network devices, the telemetry data to be specific to at least one of the different network configuration protocols and to at least one of the different telemetry protocols.

FIG. 5B illustrates a process flow or method 550 for performing health checks in a system for standardized telemetry, according to at least one embodiment. The method 500 may include a step to allow 552 the routing process to comprise an identifier which is subject to changes upon restarting the routing process. The method 500 may include a step to perform 554, by the telemetry process, a health check for the routing process. The method 500 may include a step to determine 556, as part of the health check, that the identifier has changed. The method 500 may include a step to perform 558, by the telemetry process, a health check for the routing process. The method 500 may include a step to determine 560, as part of the health check, that the identifier has changed.

FIG. 6 illustrates an example datacenter 600, in which at least one embodiment from FIGS. 1-5B may be used. For instance, the example datacenter 600 may be used to support standardized telemetry for a network. The example datacenter 600 may be a system that itself is subject to standardized telemetry for a network.

In at least one embodiment, as in FIG. 6, datacenter infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (“CPUs”) or other processors (including accelerators, field programmable gate arrays (FPGAs), graphics processors, etc.), memory devices (such as dynamic read-only memory), storage devices (such as solid state or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of the above-mentioned computing resources.

In at least one embodiment, grouped computing resources 614 may include separate groupings of node C.R. s housed within one or more racks (not shown), or many racks housed in datacenters at various geographical locations (also not shown). Separate groupings of node C.R. s within grouped computing resources 614 may include grouped compute, network, memory or storage resources that may be configured or allocated to support one or more workloads. In at least one embodiment, several node C.R. s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for datacenter 600. In at least one embodiment, resource orchestrator may include hardware, software or some combination thereof.

In at least one embodiment, as shown in FIG. 6, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 628 for large-scale data processing (such as “big data”). In at least one embodiment, job scheduler 622 may include a Spark driver to facilitate scheduling of workloads supported by various layers of datacenter 600. In at least one embodiment, configuration manager 624 may be capable of configuring different layers such as software layer 630 and framework layer 620, including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resource 614 at datacenter infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. One or more types of applications may include, but are not limited to, any number of a genomics application, a cognitive compute, and a machine learning application, including training or inferencing software, machine learning framework software (such as PyTorch, TensorFlow, Caffe, etc.) or other machine learning applications used in conjunction with one or more embodiments.

In at least one embodiment, any of a configuration manager 624, a resource manager 626, and a resource orchestrator 612 may implement any number and type of self-modifying actions based on any amount and type of data acquired in any technically feasible fashion. In at least one embodiment, self-modifying actions may relieve a datacenter operator of datacenter 600 from making possibly bad configuration decisions and possibly avoiding underutilized and/or poor performing portions of a datacenter.

In at least one embodiment, datacenter 600 may include tools, services, software or other resources to train one or more machine learning models or predict or infer information using one or more machine learning models according to one or more embodiments described herein. In at least one embodiment, in at least one embodiment, a machine learning model may be trained by calculating weight parameters according to a neural network architecture using software and computing resources described above with respect to datacenter 600. In at least one embodiment, trained machine learning models corresponding to one or more neural networks may be used to infer or predict information using resources described above with respect to datacenter 600 by using weight parameters calculated through one or more training techniques described herein. Deep learning may be advanced using any appropriate learning network and the computing capabilities of the datacenter 600. As such, a deep neural network (DNN), a recurrent neural network (RNN) or a convolutional neural network (CNN) may be supported either simultaneously or concurrently using the hardware in the datacenter. Once a network is trained and successfully evaluated to recognize data within a subset or a slice, for instance, the trained network can provide similar representative data for using the collected data.

In at least one embodiment, datacenter 600 may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or perform inferencing of information, such as pressure, flow rates, temperature, and location information, or other artificial intelligence services.

Inference and/or training logic 615 may be used to perform inferencing and/or training operations associated with one or more embodiments. In at least one embodiment, inference and/or training logic 615 may be used in system FIG. 6 for inferencing or predicting operations based, at least in part, on weight parameters calculated using neural network training operations, neural network functions and/or architectures, or neural network use cases described herein. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 may be used in conjunction with an application-specific integrated circuit (ASIC), such as Tensorflow® Processing Unit from Google, an inference processing unit (IPU) from Graphcore™, or a Nervana® (such as “Lake Crest”) processor from Intel Corp.

In at least one embodiment, inference and/or training logic 615 may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, code and/or data storage modules which may be used to store code (such as graph code), weight values and/or other information, including bias values, gradient information, momentum values, and/or other parameter or hyperparameter information. In at least one embodiment, each of the code and/or data storage modules is associated with a dedicated computational resource. In at least one embodiment, the dedicated computational resource includes computational hardware that further includes one or more ALUs that perform mathematical functions, such as linear algebraic functions, only on information stored in code and/or data storage modules, and results from which are stored in an activation storage module of the inference and/or training logic 615.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause the computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of the instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operations such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment, combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to the practice of the disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing an entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A network comprising one or more network devices configured to handle different network configuration protocols and different telemetry protocols, the one or more network devices associated with a routing process and with a telemetry process, wherein the routing process allows generation of telemetry data for the different network configuration protocols, and wherein the telemetry process allows repackaging of the telemetry data to be specific to at least one of the different network configuration protocols and to at least one of the different telemetry protocols.

2. The network of claim 1, wherein the different network configuration protocols comprise BGP (Border Gateway Protocol), OSPF (Open Shortest Path First), RIP (Routing Information Protocol), IS-IS (Intermediate System-to-Intermediate System), PIM (Protocol Independent Multicast), LDP (Label Distribution Protocol), BFD (Bidirectional Forwarding Detection), Babel, PBR (Policy-Based Routing), OpenFabric, or VRRP (Virtual Router Redundancy Protocol), and wherein the different telemetry protocols comprise OpenTelemetry (OTEL) or gRPC Network Management Interface (gNMI).

3. The network of claim 1, wherein the one or more network devices comprises a Linux operating system and wherein the routing process is Free Range Routing (FRR).

4. The network of claim 1, wherein the routing process and the telemetry process are configured for communication using gRPC.

5. The network of claim 1, further comprising one or more of a telemetry agent or a user experience interface, the telemetry agent or the user experience interface to provide subscription requests associated with the telemetry data to the telemetry process.

6. The network of claim 5, wherein the telemetry process is configured to repackage the subscription requests with gRPC for the routing process.

7. The network of claim 6, wherein the routing process is associated with a library of the different network configuration protocols to provide a native format of the telemetry data to the telemetry process.

8. The network of claim 7, wherein the telemetry process is to repackage the telemetry data from the native format to a format specific to the at least one of the different telemetry protocols.

9. The network of claim 1, wherein the telemetry process is to perform a health check for the routing process, wherein the routing process comprises an identifier which is subject to changes upon restarting the routing process, wherein the health check is to determine that the identifier has changed, and wherein the telemetry process is to repeat at least one subscription request for the telemetry data by reading the at least one subscription request from a configuration file and performing the repackaging of the telemetry data to be specific to the at least one of the different network configuration protocols and the at least one of the different telemetry protocols.

10. One or more circuits configured to handle different network configuration protocols of a network and to handle different telemetry protocols, the one or more circuits associated with a routing process and with a telemetry process, wherein the routing process allows generation of telemetry data for the different network configuration protocols, and wherein the telemetry process allows repackaging of the telemetry data to be specific to at least one of the different network configuration protocols and to at least one of the different telemetry protocols.

11. The one or more circuits of claim 10, wherein the one or more circuits are configured for one or more of: execution of a Linux operating system, routing using Free Range Routing (FRR), and communication using gRPC between the routing process and the telemetry process.

12. The one or more circuits of claim 10, further comprising one or more of a telemetry agent or a user experience interface, the telemetry agent or the user experience interface to provide subscription requests associated with the telemetry data to the telemetry process.

13. The one or more circuits of claim 10, further comprising one or more of: a library, of the routing process, comprising the different network configuration protocols to provide a native format of the telemetry data to the telemetry process; or configuration, of the telemetry process, to repackage the telemetry data from the native format to a format specific to the at least one of the different telemetry protocols.

14. The one or more circuits of claim 10, wherein the telemetry process is to perform a health check for the routing process, wherein the routing process comprises an identifier which is subject to changes upon restarting the routing process, wherein the health check is to determine that the identifier has changed, and wherein the telemetry process is to repeat at least one subscription request for the telemetry data by reading the at least one subscription request from a configuration file and performing the repackaging of the telemetry data to be specific to the at least one of the different network configuration protocols and the at least one of the different telemetry protocols.

15. A method for telemetry standardization, comprising:
handling, using one or more network devices in a network, different network configuration protocols and different telemetry protocols associated with telemetry in the network;
generating, by a routing process of the one or more network devices, telemetry data for the different network configuration protocols; and
repackaging, by a telemetry process of the one or more network devices, the telemetry data to be specific to at least one of the different network configuration protocols and to at least one of the different telemetry protocols.

16. The method of claim 15, further comprising one or more of:
using one or more of OpenTelemetry (OTEL) or gRPC Network Management Interface (gNMI) as the different telemetry protocols;
using BGP (Border Gateway Protocol), OSPF (Open Shortest Path First), RIP (Routing Information Protocol), IS-IS (Intermediate System-to-Intermediate System), PIM (Protocol Independent Multicast), LDP (Label Distribution Protocol), BFD (Bidirectional Forwarding Detection), Babel, PBR (Policy-Based Routing), OpenFabric, or VRRP (Virtual Router Redundancy Protocol) as the different network configuration protocols;
executing a Linux operating system in the one or more network devices; or
using Free Range Routing (FRR) for the routing process.

17. The method of claim 15, further comprising:
using gRPC for communications between the routing process and the telemetry process.

18. The method of claim 15, further comprising:
allowing subscription requests to be received in the telemetry process through a telemetry agent or a user experience interface;
repackaging, by the telemetry process, the subscription requests for gRPC with respect to the routing process; and
generating the telemetry data in the routing process based in part on the subscription requests, wherein the routing process is associated with a library of the different network configuration protocols to provide a native format of the telemetry data to the telemetry process.

19. The method of claim 18, further comprising:
repackaging, by the telemetry process, the telemetry data from the native format to a format specific to the at least one of the different network configuration protocols and the at least one of the different telemetry protocols.

20. The method of claim 18, further comprising
allowing the routing process to comprise an identifier which is subject to changes upon restarting the routing process;
performing, by the telemetry process, a health check for the routing process;
determining, as part of the health check, that the identifier has changed;
repeating, by the telemetry process, at least one subscription request for the telemetry data by reading the at least one subscription request from a configuration file; and
performing the repackaging of the telemetry data to be specific to the at least one of the different network configuration protocols and the at least one of the different telemetry protocols.
